(19) United States
(12) Patent Application Publication
(10) Pub. No.: US 2025/0231346 A1
(43) Pub. Date: Jul. 17, 2025

(54) METHODS AND DEVICES FOR EFFICIENT OPTICAL COUPLING BETWEEN OPTICAL FIBERS AND PHOTONIC INTEGRATED CHIPS

(71) Applicant: nEye Systems, Inc., Emeryville, CA (US)

(72) Inventors: Ming Chiang A. Wu, Piedmont, CA (US); Tae Joon Seok, El Cerrito, CA (US); Xiaosheng Zhang, Davis, CA (US); Sergio Fabian Almeida Loya, Moraga, CA (US); Kyungmok Kwon, El Cerrito, CA (US)

(21) Appl. No.: 19/016,561

(22) Filed: Jan. 10, 2025

Related U.S. Application Data
(60) Provisional application No. 63/620,697, filed on Jan. 12, 2024.

(51) Int. Cl. G02B 6/30

(52) U.S. Cl. CPC G02B 6/30

(57) ABSTRACT

Method and structures for edge coupling between waveguides of a photonic integrated circuit (PIC) chip with warpage and an optical fiber array. Some methods are used for measured displacements of waveguide facets due to PIC chip warpage. Some methods and structures are provided for fabricating the optical fiber array using the measured waveguide displacements to improve the optical coupling efficiency between the individual waveguides and optical fibers.

### INCORPORATION BY REFERENCE TO ANY PRIORITY APPLICATIONS

This application claims benefit under 35 U.S.C. § 119 (e) of U.S. Provisional Patent Application No. 63/620,697, entitled “METHODS AND DEVICES FOR EFFICIENT OPTICAL COUPLING BETWEEN OPTICAL FIBER ARRAYS AND PHOTONIC INTEGRATED CHIPS,” filed on Jan. 12, 2024, that is incorporated herein by reference in its entirety.

### BACKGROUND

### Field

The present disclosure is related generally to optical coupling between an optical fiber and a waveguide, and more particularly to coupling between optical fibers and waveguides fabricated on a photonic integrated chip.

### Description of the Related Art

The advent of monolithic fabrication techniques for fabrication of on-chip photonic devices and components has enabled fabrication of photonic integrated circuits (PICs) comprising a plurality of photonic devices of optically interconnected devices on a chip or substrate. A PIC used in an optical system can be in optical communication with another optical system, an optical sub-system, or an optical device. An optical connection between the PIC and another optical system or device may be established using edge coupling between a plurality of waveguides on the PIC and an aa plurality of optical fibers.

### BRIEF DESCRIPTION OF THE DRAWINGS

In the following description of the various embodiments, reference is made to the accompanying drawings which form a part hereof, and in which is shown by way of illustration various embodiments of the device. It is to be understood that other embodiments may be utilized and structural changes may be made. It should be understood that the diagrams are not drawn in scale and certain dimensions may have been exaggerated for clarity and/or emphasis.

FIG. 1A is a schematic diagram showing a side view (top panel) and a top view (bottom panel) of the edge portion of a photonic integrated circuit (PIC) die bonded to an electronic integrated circuit (EIC) forming a PIC-on-EIC stack, depicting a plurality of edge coupler waveguides and the corresponding edge coupler waveguide facets.

FIG. 1B is a schematic diagram showing a side view (top panel) and a top view (bottom panel) of the edge portion of the PIC-on-EIC stack shown in FIG. 1A aligned with an optical fiber array for fiber-to-chip optical coupling.

FIG. 2A is a schematic diagram showing side views of a warped PIC-on-EIC stack with a convex top surface (top panel), and the warped PIC-on-EIC aligned with an optical fiber array (bottom panel). The optical fiber facets are aligned to the edge waveguide coupler facets of the PIC chip for fiber-to-chip optical coupling.

FIG. 2B is a schematic diagram showing side views of a warped PIC-on-EIC stack with concave top surface (top panel), and the warped PIC-on-EIC aligned with an optical fiber array (bottom panel). The optical fiber facets are aligned to the edge waveguide coupler facets of the PIC chip for fiber-to-chip optical coupling.

FIG. 2C is a schematic diagram showing side views of a warped PIC-on-EIC stack with alternating convex and concave top surface regions (top panel), and the warped PIC-on-EIC aligned with an optical fiber array (bottom panel). The optical fiber facets are aligned to the edge waveguide coupler facets of the PIC chip for fiber-to-chip optical coupling.

FIG. 3 is a schematic diagram showing a side view of the warped PIC-on-EIC depicting example regions of the warped PIC-on-EIC shown in FIG. 2C, which may be used to characterize the warpage for adjusting the position of the corresponding optical fibers.

FIG. 4A is a schematic diagram showing a top view of the edge portion of a PIC-on-EIC stack aligned with an array of optical fibers where an end facet of each optical fiber includes a microlens for efficient fiber-to-waveguide optical coupling.

FIG. 4B is a schematic diagram showing a top view of the edge portion of a PIC-on-EIC stack aligned with an array of optical fibers where a microlens is disposed on each edge coupler waveguide facet for efficient fiber-to-waveguide optical coupling.

FIG. 5A is a schematic diagram showing a side view of an optical fiber array structure including a fiber mount having a v-groove array with v-grooves having substantially identical depths and opening widths.

FIG. 5B is a schematic diagram showing a side view of a customized optical fiber array structure including a fiber mount having a v-groove array with v-grooves having tailored depths and opening widths for efficient optical coupling to a PIC with warpage.

FIG. 5C is a schematic diagram showing a closeup side view of an optical fiber positioned within a v-groove of a fiber mount depicting the width of the v-groove opening (w), the depth of the v-groove (d), the vertical offset (h) of the optical fiber (with respect to a top surface of the fiber mount), the core region of the optical fiber, and the center of the core region.

FIG. 6 is a schematic diagram showing a side view of a customized optical fiber array structure aligned with a warped PIC where individual v-grooves are tailored to align the optical fibers to the respective edge coupler waveguide facets of the PIC.

### DETAILED DESCRIPTION

The advent of monolithic fabrication techniques for fabrication of on-chip photonic devices and components has enabled fabrication of photonic integrated circuits (PICs) comprising a plurality of photonic devices of optically interconnected devices on a chip or substrate. In some cases, an entire optical system or a portion of an optical system may be fabricated on one or more chips.

In some cases, a PIC may be mounted or bonded to an electronic integrated circuit (EIC), e.g., to provide electrical connection between an electronic circuitry of the EIC and one or more optical devices or components of the PIC (e.g., detectors, lasers, modulators, heaters, attenuators, or other electronic or optoelectronic devices). In some embodiments, the PIC may be bonded to EIC via a solder bump array or matrix configured to electrically connect one or more contact pads of the EIC to one or more contact pads of the PIC. In some cases, an EIC may comprise a complementary metal oxide semiconductor (CMOS) die. In some examples, a CMOS die may comprise one or more CMOS transistors that can form an electronic circuit.

While the optical components of a PIC can be optically interconnected via monolithically fabricated waveguides, in some cases, the PIC may receive and/or transmit optical signals from/to an optical system or device (e.g., an optical source, another PIC, a fiber coupled optical device, and the like). Fiber optic waveguides (also referred to as optical fibers) are commonly used to establish optical connection (e.g., low loss optical connection) between a PIC and another optical device, optical system, or optical sub-system. As such, efficient optical coupling between optical fibers and a PIC can play an important role in the performance (e.g., power efficiency, signal-to-noise ratio, and the like) of an optical system comprising the PIC optically connected to another optical device or optical sub-system.

In some embodiments, fiber optic coupling to a PIC may comprise edge coupling one or more optical fibers (e.g., periodic or aperiodic optical fiber arrangements including an array) to the PIC via a facet of the PIC (herein referred to as edge-coupling facet). In some cases, a PIC may comprise optical waveguides (herein referred to as edge coupler waveguides) configured to optically connect one more optical devices and/or components of the PIC, to one or more optical fibers (e.g., periodic or aperiodic optical fibers of an arrangement including an optical fiber array) via the edge-coupling facet of the PIC. In some examples, an edge coupler waveguide can be extended from an optical device or waveguide formed on the PIC, to an edge region of the PIC. In some such examples, the edge coupler waveguide may be terminated by an edge coupler waveguide facet at or near the edge-coupling facet of the PIC. In some embodiments, the edge-coupling facet may be formed by cleaving (or cleaving and polishing) the PIC chip near output ends of the edge coupler waveguides. In some cases, the edge-coupling facet may comprise one or more edge coupler waveguide facets formed during the cleaving process. In some examples, an edge coupler waveguide facet may be formed prior to cleaving the PIC (e.g. by an etching process). An edge-coupling facet and/or the corresponding edge coupler waveguide facets may serve as one or both input and output optical ports of the PIC. In some cases, the edge-coupling facet and/or the corresponding edge coupler waveguide facets may be coated with an antireflection (AR) layer configured to reduce optical reflection from an interface between edge coupler waveguide facets and air gap between the edge-coupling facet and the fiber optic array. In some cases, the AR layer may comprise a plurality of sublayers having refractive indices and thickness configured to reduce optical reflection at the edge-coupling facet and/or the corresponding edge coupler waveguide facets within a specified wavelength range.

In some cases, the edge-coupling facet may comprise a surface region substantially perpendicular to a major surface of the PIC (e.g., a surface on which a photonic circuit is formed or a surface parallel to the surface on which a photonic circuit is formed). In some cases, the edge-coupling facet may be extended along a first direction parallel to the major surface (e.g., a flat or planar major surface) of the PIC or a plane corresponding to the major surface of the PIC chip. In some embodiments, a plurality of edge coupler waveguide facets can be arranged along the edge-coupling facet such that a vertical distance between edge coupler waveguide facets and the major surface of the PIC remains substantially constant along the edge-coupling facet. The vertical distance can be a distance along a second direction (e.g., a vertical direction) perpendicular to the major surface of the PIC chip or the plane corresponding to the major surface of the PIC chip. Such arrangement may facilitate optical alignment and coupling between the plurality of edge coupler waveguide facets and a plurality of optical fibers arranged such that the centers of all fiber cores are in a common plane (herein referred to as fiber array plane). For example, when the distances between consecutive edge coupler waveguide facets is matched to those of the respective fiber cores, all the fiber cores may be simultaneously aligned with the respective edge coupler waveguide facets by aligning one fiber core to an edge coupler waveguide facet and keeping the fiber array plane substantially parallel to the major surface of the PIC chip. In some examples, the plurality of edge coupler waveguide facets may comprise a periodic arrangement or periodic array having a pitch (e.g., waveguide facet-to-waveguide facet distance) equal to that of a periodic arrangement of optical fibers (e.g., a periodic fiber array) having the same pitch (e.g., fiber-to-fiber distance). In some other examples, the plurality of edge coupler waveguide facets and the plurality may not be periodic (e.g., it may comprise an aperiodic array) and the lateral positions of the edge coupler waveguide facets may be matched to those of a non-periodic or aperiodic arrangement of optical fibers (e.g., an aperiodic fiber array).

In some cases, during or after fabrication, a PIC (or the wafer on which the PIC is fabricated) may be deformed or warped, e.g., due to process-stress, or mismatch between physical properties of different layers, and the like. In some cases, the warpage may be caused by different stress levels in different materials, different thermal expansion of different materials, nonideality in the fabrication processes of the PIC. In some cases, where the PIC is bonded to a warped EIC (e.g., a CMOS die), the warpage of the EIC may cause the warpage of the PIC. In some other cases, nonideality in the PIC-on-EIC bonding process may cause the warpage of the PIC and EIC. As such in some cases, a flat PIC may become warped after bonding to an EIC or other substrates (e.g., carrier substrates).

Such warpage may cause the edge coupler waveguide facets to be displaced with respect to each other along the vertical direction perpendicular to a plane (e.g., a non-warped surface) corresponding to a major surface of the warped PIC. Such displacement may reduce the optical coupling between some of the edge coupler waveguides and respective optical fibers of an optical fiber array having a flat fiber array plane. In some cases, when the PIC is warped, the plane corresponding to it major surface can be a plane perpendicular to at least two cleaved facets of the PIC extended along two different directions, and the vertical direction can be a direction perpendicular to that plane.

This disclosure is directed to edge coupling between waveguides of a photonic integrated circuit (PIC) chip and an optical fiber array when the PIC has warpage. Some of the methods are directed to measuring displacements of edge coupler waveguide facets (e.g., with respect to a nominal plane corresponding to a major surface of the PIC), due to PIC chip warpage. Some methods and structures are directed to customized optical fiber array structures having fiber cores positioned based on the measured displacements for the edge coupler waveguide facets to improve the optical coupling efficiency between the individual edge coupler waveguide facets and the optical fibers. Some embodiments may use a microlens array between the integrated circuit (PIC) chip and the optical fiber array to improve optical coupling. In various implementations, the microlens array may be disposed on the core regions of the individual optical fiber facets or on the individual edge coupler waveguide facets.

In some embodiments, the PIC chip may comprise a substrate and a waveguide layer disposed on the substrate. In some embodiments, the edge coupler waveguides may be fabricated on or within the waveguide layer. In some examples, the substrate may comprise silicon (e.g., a silicon wafer). In some examples, the waveguide layer may comprise silicon dioxide (SiO₂). In some examples, an edge coupler waveguide may comprise silicon nitride (SiN). In some embodiments, the PIC chip may comprise a waveguide layer comprising SiN edge coupler waveguides embedded in a silicon dioxide layer (also referred to as a cladding layer) disposed on a silicon substrate. In some embodiments, the PIC chip may comprise a waveguide layer comprising silicon edge coupler waveguides embedded in a silicon dioxide layer (also referred to as a cladding layer) disposed on a silicon substrate. In some other embodiments, the edge coupler waveguides, the substrate, and/or the cladding layer may comprise other materials. In some examples, the edge coupler waveguides may a comprise a first material and the cladding may comprise a second material having a refractive index lower than that of the first material.

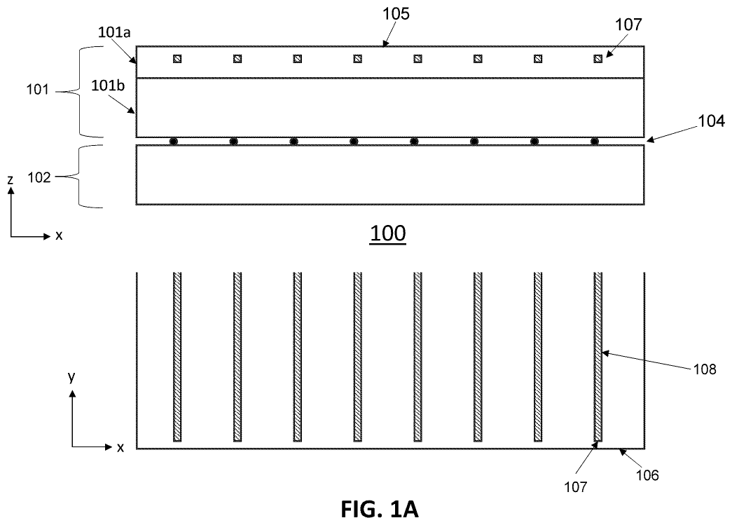

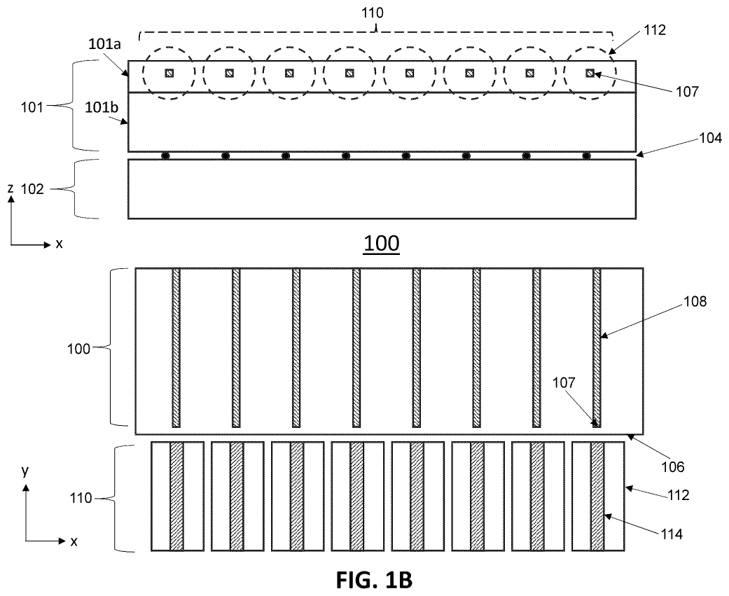

FIG. 1A. is a schematic diagram showing a side view (top panel) and a top view (bottom panel) of an edge portion (or region) of a photonic integrated circuit (PIC) die 101 (or PIC 101) stacked on or above, e.g., bonded to, an electronic integrated circuit (EIC) die 102 (or EIC 102) depicting a plurality of edge coupler waveguides and the corresponding edge coupler waveguide facets. In some embodiments, the PIC 101 may be bonded to the EIC 102 via a bonding interface 104 to form a composite structure herein referred to as a PIC-on-EIC stack 100. In some cases, the bonding interface 104 may comprise a solder bump array or matrix. In some cases, the EIC 102 may comprise a complementary metal-oxide-semiconductor (CMOS) die including CMOS transistors in electrical communication with the PIC 101 (e.g., for controlling, monitoring, or otherwise exchange electrical signals with photonic elements of the PIC 101).

The PIC 101 may comprise a waveguide layer 101a within which one or more edge coupler waveguides are embedded. The waveguide layer 101a may be fabricated on a substrate 101b. In some examples, the waveguide layer 101a may comprise silicon dioxide and the substrate 101b may comprise silicon. In some embodiments, an edge coupler waveguide 108, and the corresponding edge coupler waveguide facet 107, may have a thickness (e.g., along z-axis) from 200 nm to 350 nm, 350 nm to 400 nm, or other thicknesses, and a width (e.g., along x-axis) in the range of 100 nm to 300 nm, or other widths. In some embodiments, the edge coupler waveguide facets may form a periodic array of facets having a pitch from 100 to 127 microns, from 127 to 250 microns, or larger or smaller values. In some cases, the corresponding edge coupling waveguide array can be a periodic waveguide array with the same or different pitch compared to the periodic array of facets. For example, at least a portion of the periodic waveguide array can have a pitch different (e.g., smaller) than the pitch of the periodic array of facets. In some embodiments, lateral positions of at least a portion of the edge coupler waveguide facets may not be periodic.

In some embodiments, the PIC 101 may comprise an edge-coupling facet 106 extended in a first direction (e.g., along x-axis) parallel to a top major surface 105 of the PIC 101 and the plurality of edge coupler waveguide facets can be arranged along the edge-coupling facet 106 such that a vertical distance (e.g., along z-axis) between edge coupler waveguide facets (shown as small squares) and the top major surface 105 of the PIC 101 remains substantially constant along the first direction (e.g., x-axis). The vertical distance can be a distance along a second direction (e.g., parallel to z-axis). In some cases, the second direction can be substantially orthogonal to the first direction. As such in the example shown, the PIC die 101 and the EIC (CMOS) die 101 are flat and the edge coupler waveguide facets are located on a flat plane parallel to the x-y plane and perpendicular to z-axis. Since the PIC 101 is not warped, in this case the top major surface 105 of the PIC 101 is can be plane with respect to which the vertical direction is defined and the vertical positions of the edge coupler waveguide facets are measured or determined.

FIG. 1B is a schematic diagram showing a side view (top panel) and top view of (bottom panel) the edge portion of the PIC-on-EIC stack 100 shown in FIG. 1A aligned with an optical fiber array 110 for fiber-to-chip optical coupling. An individual optical fiber 112 of the optical fiber array 110 may comprise a core region 114 (also referred to as fiber core) surrounded by a cladding where light substantially resides within the fiber core 114 and is guided through the fiber core 114. In some examples, the optical fiber array 110 may comprise a plurality of optical fibers positioned such that the centers of the corresponding fiber cores are substantially within a flat plane parallel to top major surface of the PIC 101 or a top surface of a fiber mount on which the optical fiber array is formed (e.g., parallel to x-y plane). Since the edge coupler waveguide facets are located on a flat plane (parallel to x-y plane), when the optical fibers and the edge coupler waveguide facet are uniformly (e.g., periodically) spaced in a lateral direction (e.g., along the x-axis) with the same pitch, each fiber core 114 can be aligned with the respective edge coupler waveguide facet 107 to provide efficient fiber-to-waveguide coupling. While in the examples shown in FIGS. 1A and 1B the edge coupler waveguide facets of the PIC 101 are periodically positioned along the lateral direction, the embodiments are not so limited and, in some cases, the lateral positions of the edge coupler waveguide facets of a PIC may not be periodic along the lateral direction. In these embodiments the lateral positions of the optical fibers of an optical fiber array optically coupled to the edge coupler waveguide facets may match the lateral positions of the edge coupler waveguide facets and thereby may not be periodic along the lateral direction.

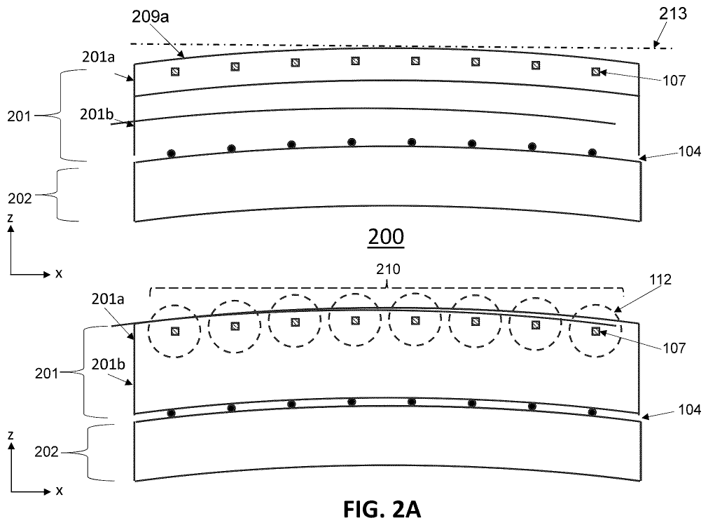

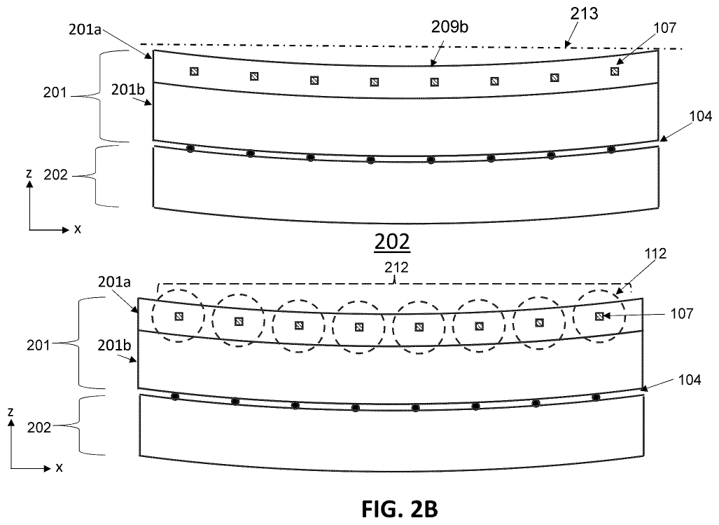

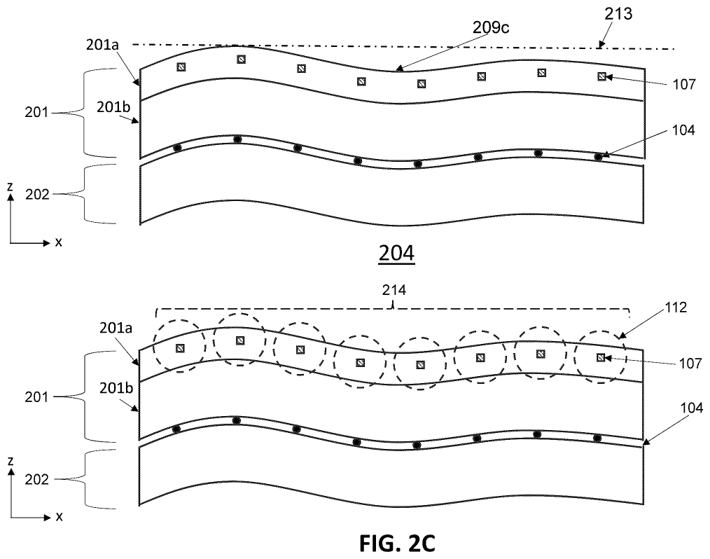

As mentioned above, in practice, a PIC and/or a CMOS die may have a warpage, e.g., a warpage caused by fabrication-induced stress. The warpage may be in a single direction as shown in FIGS. 2A and 2B, or comprise a pattern (e.g., a random pattern) as shown in FIG. 2C. Independent of the warpage direction or profile, when the PIC 101 has warpage, the edge coupler waveguide facets are no longer located on a flat plane. As such, when the fiber cores of an optical fiber array are in a flat plane, efficient coupling between all the optical fibers of the optical fiber array and all the edge coupler waveguide facets may not be possible. In some of the embodiments disclosed herein, efficient optical coupling between the optical fibers of an optical fiber array and edge coupler waveguide facets of a warped PIC may be achieved, by arranging the optical fibers such that the corresponding fiber cores form a non-flat pattern (e.g., a warped pattern) that matches with the warpage of the edge coupler waveguide facets and thereby enables optical alignment between all or most edge coupler waveguide facets and the respective optical fibers. Some methods disclosed herein may comprise, tailoring the relative positions of the optical fibers of an optical fiber array along a vertical direction perpendicular to a plane corresponding to a major surface (e.g. a warped major surface) of the warped PIC or a major surface (e.g., planar major surface) of a fiber mount on which the optical fiber array is formed (e.g., along z-axis) according to relative vertical displacements (e.g., measured relative vertical displacements) of the edge coupler waveguide facets of the PIC 101, e.g., with respect to a plane corresponding to a major surface (e.g., a warped major surface) of the warped PIC.

FIG. 2A is a schematic diagram showing side views of a nonlimiting example of a warped PIC-on-EIC stack 200 (top panel) comprising a warped PIC 201 with a convex top major surface 209a, and the warped PIC-on-EIC stack 200 aligned with a customized optical fiber array 210 (bottom panel). The edge coupler waveguide facets of the warped PIC 201 are aligned with the fiber cores of the customized optical fiber array 210 to provide fiber-to-chip optical coupling.

FIG. 2B is a schematic diagram showing side views of another nonlimiting example of a warped PIC-on-EIC stack 202 (top panel) comprising a warped PIC 201 with a concave top surface 209b, and the warped PIC-on-EIC 202 aligned with a customized optical fiber array 212 (bottom panel). The edge coupler waveguide facets of the warped PIC 201 are aligned with the fiber cores of the customized optical fiber array 212 to provide fiber-to-chip optical coupling.

FIG. 2C is a schematic diagram showing side views of yet another nonlimiting example of a warped PIC-on-EIC stack 204 (top panel) comprising a warped PIC 201 with a warped top surface 209c having alternating convex and concave regions, and the warped PIC-on-EIC stack 204 aligned with a customized optical fiber array 214 (bottom panel). The edge coupler waveguide facets of the warped PIC 204 are aligned with the fiber cores of the customized optical fiber array 214 to provide fiber-to-chip optical coupling (bottom panel).

As shown in FIGS. 2A-2C in various implementations where a PIC is warped and its edge coupler waveguide facets are vertically displaced (e.g., they are not positioned within a flat plane), a customized optical fiber array may be formed such that relative vertical displacements of the corresponding fiber cores with respect to a plane 213 corresponding to a major surface (e.g., a top major surface) of the warped PIC, match those of the edge coupler waveguide facets. In some embodiments, the customized optical fiber array may be fabricated by first measuring the relative vertical displacements of the edge coupler waveguide facets in the wrapped PIC (e.g., with respect to the plane 213 corresponding to the top major surfaces 209a-c), and the measured relative vertical displacements may be used to design and fabricate a customized optical fiber mount configured to vertically align the individual optical fibers of the customized optical fiber array to match the vertical alignments of the respective edge coupler waveguide facets. In some embodiments, the customized optical fiber array may be fabricated by first measuring the variation of the vertical positions (along z-axis) of edge coupler waveguide facets with respect to the plane 213 along the lateral direction (e.g., along the x-axis) and using the measured variation of the vertical positions to design and fabricate a customized optical fiber mount configured to vertically align the individual optical fibers of the customized optical fiber array to match the vertical alignments of the respective edge coupler waveguide facets.

In some embodiments, a method of designing and forming an optical fiber array for optical coupling to coupler waveguides of a warped PIC (e.g., PICs in the PIC-on-EIC stacks 200, 202, 204) may comprise characterizing the warpage of the warped PIC or the warpage profile (z-displacement profile along x-axis also referred to height profile) of the corresponding edge coupler waveguide facets.

In some embodiments, a warped PIC may comprise a plurality of edge coupler waveguide facets that their relative vertical positions varies along the lateral direction by more than 2%, more than 4%, more than 6%, more than 8%, or more than 10% of an average vertical position the plurality of edge coupler waveguide facets, where the vertical position is measured with respect to a plane corresponding to a major surface of the warped PIC (e.g., plane 213 corresponding to top major surfaces 209a-c), and the vertical direction (e.g., z-direction) being perpendicular to the plane. In some embodiments, the warpage profile may comprise a variation of the vertical positions along the lateral direction (e.g., along the x-axis).

In various implementations, different portions, regions, facets, or surfaces of a warped PIC may be measured to determine the warpage profile. For example, a surface profile of the PIC 204 (e.g., the profile the warped top major surface 209c) may be measured (e.g., using an optical or stylus based profilometer). The surface profile may be used to determine the warpage profile of the edge coupler waveguide facets (e.g., variation of the positions of the edge coupler waveguide facets along z-axis). In some embodiments, the warpage profile of the edge coupler waveguide facets may be determined by measuring (e.g., using imaging) the profile of the interface between the waveguide layer 101a and the substrate 101b. In some embodiments, the warpage profile of the edge coupler waveguide facets may be determined by directly imaging the edge coupler waveguide facets.

In embodiments, the warpage profile may comprise or can be derived from a measured height profile of the PIC. In some embodiment, the height profile may comprise variation of a distance between a top major surface of the PIC and a flat plane associated with the top major surface, along the lateral direction. In some such embodiments, the height profile can be measured by measuring a surface profile of the top major surface of the PIC (e.g., using a profilometer). In some embodiment, the height profile may comprise vertical variation profile of an interface (e.g., between a waveguide layer and the PIC substrate) or the edge coupler waveguide facets, along the lateral direction. In some such embodiments, the height profile can be measured by obtaining an image of a facet of the PIC (e.g., an edge-coupling facet of the PIC).

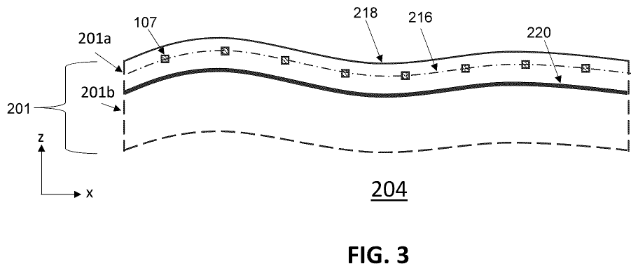

FIG. 3 is a schematic diagram depicting example regions of the warped PIC-on-EIC stack 204 shown in FIG. 2C, which may be measured using three different methods described below to determine the warpage profile of the corresponding edge coupler waveguide facets. In various implementations, geometrical features of one or more of these regions may be directly proportional to the warpage profile of the edge coupler waveguide facets or may be used to estimate or calculate the warpage profile of the edge coupler waveguide facets. In some examples, the warpage profile of the edge coupler waveguide facets may comprise variation of vertical distances of edge coupler waveguide facets with a respect to a flat plane.

Method 1: In some embodiments, a chip facet of the PIC 204 may be imaged by a microscope. For example, the edge coupling waveguide facet of the PIC 204 may be imaged, and individual edge coupler waveguide facets may be identified in the microscopic image. In some examples, an edge coupler waveguide facet may be identified using a digital image processing method. In some cases, once the edge coupler waveguide facets are identified, relative locations (relative vertical variations or displacements) of the identified waveguide facets may be measured from the image, e.g., to generate the warpage profile 216. In some examples, warpage profile of the edge coupler waveguide facets may comprise z-coordinates of different waveguide edge coupler waveguide facets (e.g., a center of a waveguide facet) distributed along x-axis.

Method 2: In some embodiments, it may be considered that the warpage of a plane defined by the edge coupling waveguides (silicon nitride (SiN) waveguides) is approximately or substantially the same as the warpage of the top surface of the warped PIC die 201. In some such embodiments, the profile of the top surface of warped PIC 201 (or the top surface 218 of the waveguide layer 201a, e.g., an SiO₂ layer) may be measured by a surface profiler. Subsequently, the vertical offset of each edge couple waveguide facet can be calculated or extracted from the measured warpage of the top surface of the waveguide layer at the corresponding lateral position (e.g., along x-axis).

Method 3: In some embodiments, it may be considered that the warpage profile of a plane defined by the edge coupling waveguides (SiN waveguides) is approximately or substantially the same as the warpage profile of the interface 220 between the waveguide layer 201a and the substrate 201b (Si—SiO₂ interface) of the warped PIC 201. In some cases, the warpage profile of the interface 220 between the waveguide layer 201a and the substrate 201b interface can be measured by a profiler and/or imaging system. In some cases, the vertical offset of individual edge coupler waveguide facets (along z-axis) can be calculated or extracted from the measured warpage of the Si—SiO₂ interface at the corresponding lateral position (position along x-axis). In some embodiments, the warpage profile of the PIC may be measured by measuring a vertical variation profile of the interface 220 between the waveguide layer 201a and the substrate 201b.

In some embodiments, a warped PIC may comprise a warpage or warpage profile that can be measured, characterized, or quantified using one the method described above or other methods. In some embodiments, the warped PIC may comprise a warped interface, a warped surface, or a nominal warped path or line defined by an edge coupler waveguide facets. In some examples, vertical positions of laterally separated points (e.g., along x-axis) on the warped interface, the warped surface, the warped path may vary by more than 2%, more than 4%, more than 6%, more than 8%, more than 10%, or percentage in a range defined by any of these values, of an average vertical position of the laterally separated points. In some cases, the vertical position can be measured with respect to a plane corresponding to a major surface of the warped PIC (e.g., plane 213 corresponding to top major surfaces 209a-c), where the vertical direction (e.g., z-direction) can be perpendicular to the plane.

Once the warpage profile of a warped PIC is measured or determined (e.g., using one of the methods described above or other methods), the measured/determined warpage profile may be used to determine the positions (e.g., vertical positions) of individual optical fibers in the optical fiber array. In some embodiments, after determining the positions of the individual optical fibers, a customized optical fiber array comparison fiber facets having tailored vertical positions may be fabricated by fabricating a customized fiber mount and mounting the individual optical fibers on the customized fiber mount (e.g., a v-groove array) configured to provide the tailored and customized relative vertical displacements for different optical fibers of the customized optical fiber array. Such customized and/or tailored optical fiber positioning (according to the measured edge coupler waveguide facet locations or the measured warpage profile of the PIC) can facilitate and improve optical coupling efficiency between individual edge coupling waveguides and the respective optical fibers.

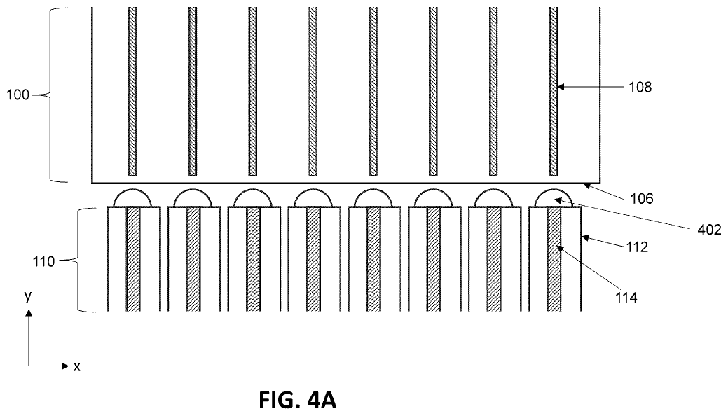

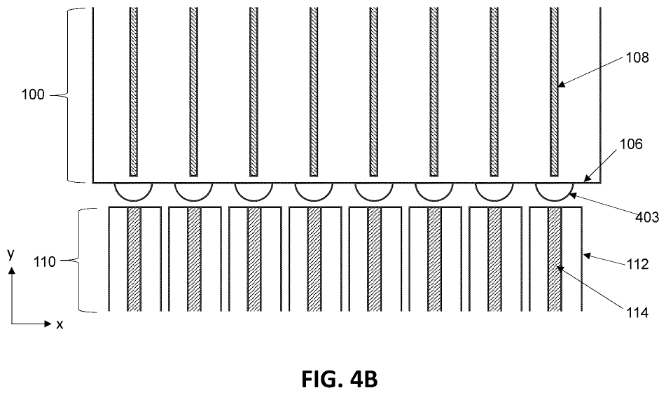

In some embodiments, one or more microlenses may be disposed on corresponding one or more facets of an optical fiber array (e.g., the optical fiber array 110, or the customized optical fiber arrays 210, 212, or 214) or on corresponding one or more of the edge coupler waveguide facets of a PIC chip (e.g., the flat PIC 101, or the warped PIC 201 in FIGS. 2A, 2B, and 2C) to improve optical coupling efficiency between the individual optical fibers and he respective edge coupling waveguides. FIG. 4A is a schematic diagram showing a top view of the edge portion (or region) of a PIC-on-EIC stack aligned with an array of optical fibers where microlenses are disposed or formed on end facets of individual optical fibers to improve fiber-to-waveguide optical coupling. FIG. 4B is a schematic diagram showing a top view of the edge portion (or region) of a PIC-on-EIC stack aligned with an array of optical fibers where microlenses are formed or disposed on individual edge coupler waveguide facets for efficient fiber-to-waveguide optical coupling.

In some examples, with reference to FIG. 4A, a microlens 402 may be disposed on a facet of an optical fiber 112 and over core region 114 of the fiber 112 to match an optical mode profile (e.g., mode size) of the optical fiber 112 to an optical mode profile (e.g., mode size) of the corresponding edge coupler waveguide 108. In some examples, with reference to FIG. 4B, a microlens 403 formed or disposed on an edge-coupling facet 106 may be configured to match an optical mode profile (e.g., mode size) of the edge coupler waveguide 108 to an optical mode profile (e.g., mode size) of corresponding optical fiber 112.

In some implementations, the microlenses may be attached, 3D printed, or fabricated (e.g., using UV curing) on the PIC chip facet or the fiber array facet. In some cases, an end region of an optical fiber close to the edge-coupling facet 106 may be shaped (e.g., tapered) to form a lens. For example, the optical fiber can be cleaved and then tapered by wet etching or thermal treatment. In some other embodiments, an optical fiber of the optical fiber array may comprise a numerical aperture (e.g., high numerical aperture) configured such that a size (e.g., a beam waist) of the beam transmitted via the optical fiber is matched to the mode size of a respective edge coupler waveguide.

Some embodiment disclosed herein may provide structures for fabricating an optical fiber array having a vertical displacement profile matched to that of the edge coupler waveguide facets of a PIC to which the optical fiber array may be coupled. In some embodiments, these structures may comprise fiber mounting substrates configured for positioning and stabilizing (e.g., mechanically stabilizing) the optical fibers of the optical fiber array according to a measure warpage profile of the corresponding PIC (e.g. the warpage profile of the edge coupling waveguide facets of the PIC).

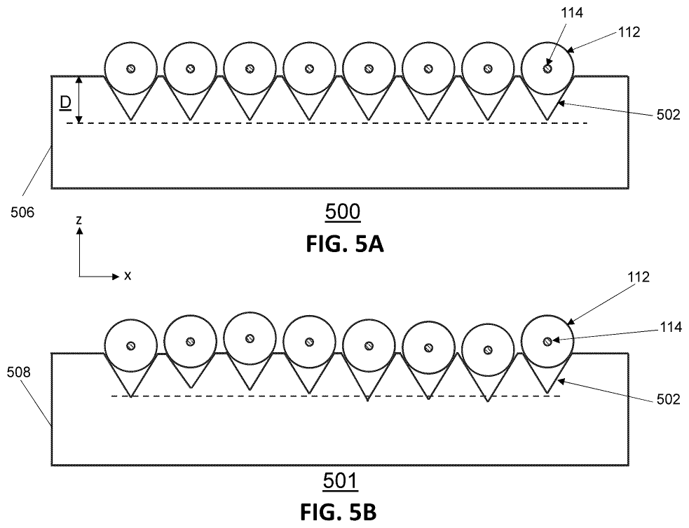

FIG. 5A is a schematic diagram showing a side view of optical fiber array structure 500 fabricated on an optical fiber mount 506 (also referred to as fiber mount) with a v-groove pattern or array. In some examples, the optical fiber mount 506 may comprise a patterned fiber substrate comprising a plurality of grooves such as v-shaped grooves (herein referred to as v-grooves), or grooves have other shapes (e.g., cross-sectional shapes) such as rectangular, circular, elliptical and the like. In some embodiments, the fiber substrate or a fiber mount may comprise any mounting structures configured to position and stabilize the optical fibers. In some embodiments, the fiber mount may comprise a plurality of v-grooves (e.g., a periodic or aperiodic arrangement of v-grooves or an array of grooves), where an individual v-groove 502 comprises an opening width and opening depth (e.g., etch depth). In some cases, the vertical position of an individual optical fiber 112, and thereby its core region 114 (e.g., with respect to a flat top or bottom surface of the optical fiber mount 506) may depend on the opening width of the corresponding v-groove 502. In the example shown, the optical fiber mount 506 comprises an array of v-grooves having substantially equal depths (D) and equal opening widths. In some cases, the v-grooves of the optical fiber array structure 500 may position the optical fibers such that centers of their core regions are located in a flat plane (e.g., parallel to a flat top or bottom surface of the optical fiber mount 506). In some examples, the optical fiber mount 506 may comprise v-grooves formed in a silicon or glass block; however, the embodiments are not so limited, and v-grooves may be formed on substrates composed of other materials (such as other semiconductors, other crystalline materials, metals, ceramics, polymers, and the like). In the example shown, the v-grooves are uniformly (e.g., periodically) distributed along x-axis. In some implementations, the optical fiber array v500 can be optically coupled to a flat PIC having edge coupling waveguide facets positioned along a straight line parallel to a major surface of the PIC (e.g., the optical fiber array structure 500 may comprise the optical fiber array 110 in FIG. 1B optically coupled to the PIC 101).

In some cases, when the optical fiber array structure 500 is aligned to a warped PIC (e.g., warped PIC 201), some of the optical fibers may not be optically coupled to the respective edge coupler waveguides with sufficient efficiency. In some embodiments disclosed herein, one or both opening width and opening depth of individual v-grooves of a customized optical fiber mounting structure may be tailored according to a determined z-displacement of the optical fiber placed in the v-groove. In some cases, the z-displacement of the optical fiber may be determined based at least in part on a measured warpage profile of the PIC.

FIG. 5B is a schematic diagram showing a side view of a customized optical fiber array structure 501 fabricated on a customized optical fiber mount 508 configured to vertically position individual optical fibers of the optical fiber array in a non-flat pattern such that the core regions of the individual optical fibers can be aligned to respective edge coupler waveguides of a warped PIC (e.g., PIC 201). In some cases, the optical fibers at different lateral positions (e.g., along x-axis) and/or their core regions may be vertically aligned according to a measured warpage profile of the corresponding warped PIC to match the locations of the edge coupler waveguide facets of the warped PIC to which the customized optical fiber array structure 501 will be coupled. In some embodiments, the v-grooves of the customized optical fiber array structure 501 may have opening depths and opening widths tailored according to the measured warpage profile of the PIC. As shown in FIG. 5B by tailoring one or both the opening width and the opening depth (e.g., etch depth) of the individual v-grooves, the relative vertical positions of the optical fibers can be customized. For example, a wider v-groove opening may position the optical fiber at lower vertical position, and a narrower v-groove opening may position the optical fiber at a higher vertical position (e.g., with respect to a flat top or bottom surface of the customized optical fiber mount 508. In some examples, e.g., when the v-grooves are formed by wet etching, increasing the width of an opening may increase depth of the opening. In other words, in some cases, width and depth of a v-groove may change proportionally during a fabrication process. The dashed line in FIG. 5B is guide to the eye indicating variation of the depths of different v-grooves resulting from tailored opening width. In some examples, wherein a difference between widths of two openings formed on the customized optical fiber mount 508 can be larger than 2%, larger than 4%, larger than 6% or larger than 8%.

In some cases, aligning and stabilizing a plurality of optical fibers on the customized optical fiber mount 508 may allow a larger ratio of optical fibers to be efficiently coupled to respective waveguide facets of a warped PIC (e.g., with an optical coupling efficiency greater than a threshold value), compared to a ratio of efficiently coupled optical fibers of a plurality of optical fibers mounted on the optical fiber mount 506 having a flat vertical profile.

FIG. 5C is a schematic diagram showing a closeup side view of an optical fiber positioned within a v-groove depicting the width (w) of the v-groove opening, the depth of the v-groove (d), the vertical offset (h) of the optical fiber, the core region 114 of the optical fiber and the center 115 of the core region. As described above, the vertical offset (h) of the optical fiber 112 may be adjusted by adjusting the width (w).

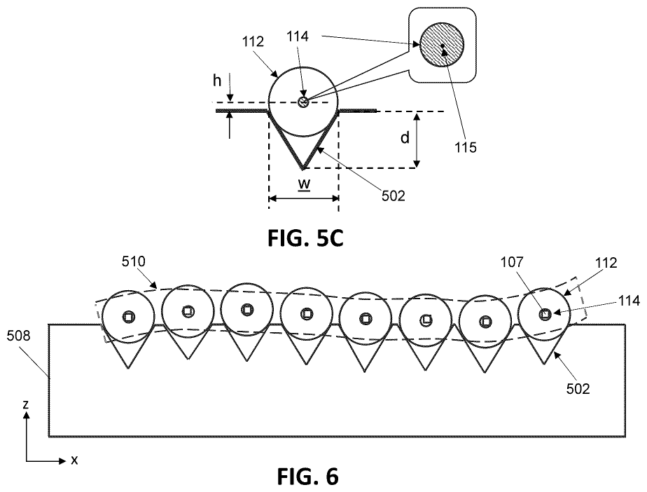

FIG. 6 is a schematic diagram illustrating a side view of a customized optical fiber array structure aligned with a warped PIC where individual v-grooves are tailored to align the core regions of the optical fibers to the respective edge coupler waveguide facets formed within the warped waveguide layer 510 of the warped PIC. The dashed line depicts the warped waveguide layer 510 of the PIC (other portions of the PIC not shown). In some embodiments, the opening width (w) and/or the opening depth (h) of individual v-grooves can be tailored to align a vertical offset (h) of the center of the optical fiber cores (e.g., with respect to the top surface of the fiber mount 508) such that fiber cores are at least vertically aligned with the respective edge coupler waveguide facets. In some cases, vertical alignment between core region 114 of an optical fiber 122 and an edge coupler waveguide facet 107 may comprise, a vertical distance between the top major surface of the fiber mount 508 and the center of the core region 114 and vertical distance between the top major surface of the fiber mount 508 and a center of the edge coupler waveguide facet 107, being substantially equal or having a difference less than 1%, less than 5%, less than 10%, less than 20%, less than 30%, less than 40%, or less than 50% of a thickness of the corresponding edge coupler waveguide.

In some embodiments, a customized optical fiber mount may comprise aligning and/or stabilizing structures different from v-grooves for positioning and stabilizing the optical fibers with respect to each other and with respect to the edge coupler waveguide facets. In these embodiments, the relative vertical positions of the optical fibers may be tailored by engineering different geometrical parameters of such aligning and/or stabilizing structures. In various implementations, the aligning and/or stabilizing structures, herein referred to as mounting structures, may comprise grooves or microstructures formed on a major surface (e.g., top major surface) of a substrate (herein referred to as fiber substrate). In some cases, the grooves or the microstructures may have different cross-sectional shapes and microstructures can be grown, bonded, disposed, or otherwise formed on the fiber substrate.

In some embodiments, the mounting structures of the customized optical fiber mount may be configured such that when a plurality of optical fibers are mounted on the customized optical fiber mount, vertical positions of the fiber facets substantially track the vertical positions of the waveguide facets of a warped PIC. In some such embodiments, the mounting structures can be individually tailored to adjust the vertical position of the individual optical fibers along the lateral direction to match a height profile of coupler waveguide facets of a PIC. For example, in some embodiments, an optical fiber mount may comprise an array of rectangular grooves in which case the vertical position of an individual optical fiber may be adjusted by adjusting a depth of the rectangular groove independent of its width. In some embodiments, an optical fiber mount may be fabricated by forming an array of mounting structures on a substrate where the mounting structures comprise geometrical features determined based at least in part on a measured warpage of the PIC. In some examples, a difference between a geometrical feature (e.g., a dimension such as width, depth, height, slope and the like) of a first mounting structure of the optical fiber mount and the corresponding feature of a second mounting structure of the optical fiber mount can be larger than 2%, larger than 4%, larger than 6% or larger than 8%.

In some embodiments, the customized optical fiber mount may comprise a periodic or an aperiodic arrangement of mounting structures (e.g., an array of mounting structures). Accordingly, the plurality of optical fiber mounted on the customized optical fiber mount may form periodic or an aperiodic arrangement of optical fibers (e.g., a fiber array).

While in the examples shown in FIGS. 2A-2C, 3, 4A-4B, 5A-5B and 6 edge coupler waveguide facets of the warped PIC are periodically positioned along the lateral direction (e.g., along x-axis), the embodiments are not so limited and, in some cases, the positions of the edge coupler waveguide facets of a warped PIC may not be periodic along the lateral direction. In these embodiments the lateral positions of the optical fibers of an optical fiber array optically coupled to the edge coupler waveguide facets may match the lateral positions of the edge coupler waveguide facets and thereby may not be periodic along the lateral direction. In some embodiments, the alignment techniques, optical fiber arrays and optical fiber mount structures, described above with respect to FIGS. 2A-2C, 3, 4A-4B, 5A-5B and 6, may be used to improve and facilitate optical coupling between a warped PIC having at least some edge coupler waveguide facets that are not periodically positioned along the lateral direction and an optical fiber array having optical fibers having lateral positions matching those of the edge coupler waveguide facets (including at least some optical fibers positioned at nonperiodic lateral positions).

### ADDITIONAL EXAMPLE EMBODIMENTS

Various additional example embodiments of the disclosure can be described by the following examples:

### Example Embodiments I

Example 1. A photonic system comprising:
a photonic integrated circuit (PIC) comprising a plurality of optical waveguides formed on a PIC substrate, different ones of the optical waveguides having waveguide facets terminating at an edge surface of the PIC at different vertical distances relative to a plane corresponding to a major surface of the PIC substrate; and
a plurality of optical fibers disposed on a fiber substrate, the optical fibers terminating with fiber facets corresponding to the waveguide facets, wherein different ones of the fiber facets terminate at different vertical distances relative to a plane corresponding to a major surface of the fiber substrate,
wherein the different vertical distances of the fiber facets substantially track the different vertical distances of the corresponding waveguide facets.

Example 2. The photonic system of Example 1, wherein the waveguide facets are periodically arranged along a lateral direction parallel to the plane corresponding to the major surface of the PIC substrate.

Example 3. The photonic system of Example 1 or Example 2, wherein the fiber facets are periodically arranged in a lateral direction parallel to the plane corresponding to the major surface of the fiber substrate.

Example 4. The photonic system of Example 1, wherein at least some of the waveguide facets and the corresponding fiber facets are not positioned periodically.

Example 5. The photonic system of any of one the above Examples, wherein the fiber substrate has the major surface patterned such that the different vertical distances of the fiber facets substantially track the different vertical distances of the waveguide facets.

Example 6. The photonic system of any one of the above Examples, wherein the different vertical distances of the waveguide facets are caused by warpage of the PIC during fabrication.

Example 7. The photonic system of any one of the above Examples, wherein the different vertical distances of the fiber facets are caused by different opening widths of grooves formed on the major surface of the fiber substrate.

Example 8. The photonic system of any one of the above Examples, wherein the different vertical distances of the fiber facets are caused by different depths of grooves formed on the major surface of the fiber substrate.

Example 9. The photonic system of any one of Examples 7 and 8, wherein the grooves are positioned at periodic lateral positions.

Example 10. The photonic system of any one of the above Examples, wherein the PIC comprises a waveguide layer disposed over the PIC substrate.

Example 11. The photonic system of Example 10, wherein the waveguide layer comprises silicon dioxide and the PIC substrate comprises silicon.

Example 12. The photonic system of Example 10, wherein the optical waveguides comprise silicon nitride waveguides embedded within waveguide layer.

Example 13. The photonic system of any one of the above Examples, wherein the fiber substrate comprises a fiber mount.

Example 14. The photonic system of Example 13, wherein the fiber mount comprises mounting structures configured to position and stabilize the optical fibers.

Example 15. The photonic system of Example 14, wherein the mounting structures comprise a plurality of grooves having different depths.

Example 16. The photonic system of Example 15, wherein the plurality of grooves comprises a plurality of v-shaped grooves.

Example 17. The photonic system of Example 16, wherein the plurality of v-shaped grooves is configured to establish relative vertical displacements between the fiber facets.

Example 18. The photonic system of any one of the above Examples, further comprising a plurality of microlenses disposed between plurality of waveguide facets and the corresponding fiber facets.

Example 19. The photonic system of Example 18, wherein the plurality of microlenses are disposed on the waveguide facets.

Example 20. The photonic system of Example 18, wherein the plurality of microlenses are disposed on the fiber facets.

### Example Embodiments II

Example 1. An optical fiber arrangement comprising:
a plurality of optical fibers disposed on a fiber substrate having formed thereon a plurality of grooves extending in a lengthwise direction of the optical fibers, wherein the grooves have different depths such that the optical fibers terminate with fiber facets at different vertical distances relative to a plane corresponding to a major surface of the fiber substrate.

Example 2. The optical fiber arrangement of Example 1, wherein the grooves comprise v-shaped grooves.

Example 3. The optical fiber arrangement of Example 2, at least some of the v-shaped grooves have different opening widths.

Example 4. The optical fiber arrangement of Example 2, further comprising a plurality of microlenses disposed over at least some of the fiber facets.

Example 5. The optical fiber arrangement of Example 1, wherein the optical fibers are arranged to optically couple to a plurality of optical waveguides of a photonic integrated circuit (PIC), wherein different ones of the optical waveguides have waveguide facets terminating at an edge surface of the PIC at different vertical distances relative to a plane corresponding to a plane corresponding to a major surface of the PIC.

Example 6. The optical fiber arrangement of Example 5, wherein the different vertical distances of the waveguide facets are caused by the PIC having a measurable warpage.

Example 7. The optical fiber arrangement of Example 6, further comprising a plurality of microlenses disposed over at least some of the waveguide facets.

Example 8. The optical fiber arrangement of Example 5, wherein the optical fibers and the PIC form the photonic system according to any of the Examples in Example Embodiments I, IV, and V.

### Example Embodiments III

Example 1. A method of fabricating an optical fiber array for optical coupling to a photonic integrated circuit (PIC), the method comprising:
providing a PIC comprising an array of optical waveguides formed on a PIC substrate, the optical waveguides terminating with waveguide facets at an edge of the PIC at lateral positions along a lateral direction along a major surface of the PIC substrate and different vertical positions in a vertical direction orthogonal to a plane corresponding to the major surface of the PIC substrate;
measuring a height profile of the PIC along the lateral direction;
determining the different vertical positions of the waveguide facets based at least in part on the measured height profile; and
fabricating an array of optical fibers on a fiber substrate to have fiber facets arranged along lateral positions corresponding to the lateral positions of the waveguide facets in the lateral direction and different vertical positions in the vertical direction, wherein the vertical positions of the fiber facets substantially track the vertical positions of the waveguide facets.

Example 2. The method of Example 1, wherein the fiber substrate has a major surface patterned such that the vertical positions of the fiber facets substantially track the vertical positions of the waveguide facets.

Example 3. The method of Example 1, wherein the height profile of the PIC comprises variation of a vertical distance between a top major surface of the PIC and a flat plane, along the lateral direction.

Example 4. The method of Example 1, wherein measuring the height profile of the PIC comprises measuring a surface profile of a top major surface of the PIC using a profilometer.

Example 5. The method of Example 1, wherein measuring the height profile of the PIC comprises measuring a vertical variation profile of an interface between waveguide layer and the PIC substrate, along the lateral direction.

Example 6. The method of Example 1, wherein measuring the height profile of the PIC comprises obtaining an image of the waveguide facets and measuring a vertical variation profile of the waveguide facets using the image.

Example 7. The method of Example 1, wherein positioning a plurality of fibers based on the determined vertical positions between fiber comprises fabricating a fiber mount having a plurality of v-grooves and placing a plurality of optical fibers within the plurality of v-grooves, wherein one or both opening width and depth of at least two v-grooves are different.

Example 8. A method of fabricating an optical fiber array, the method comprising:
providing a substrate;
forming a plurality of v-grooves on the substrate, the plurality of grooves arranged at lateral positions along a lateral direction along a major surface of the substrate; and
disposing a plurality of optical fibers on the substrate by placing individual optical fibers in the individual grooves;
wherein the optical fibers terminate with fiber facets arranged along the lateral positions and the grooves are configured such that fiber facets have different vertical positions in a vertical direction orthogonal to a plane corresponding to the major surface of the substrate.

Example 9. The method of Example 8, wherein the different vertical positions of the fiber facets substantially track different vertical positions of waveguide facets of a photonic integrated circuit (PIC) comprising an array of optical waveguides formed on a PIC substrate, the optical waveguides terminating with the waveguide facets at an edge of the PIC, wherein positions of the waveguide facets along the lateral direction correspond to the lateral positions of the fiber facets.

Example 10. The method of Example 8, wherein the plurality of grooves comprise a plurality of v-shaped grooves are configured such that the fiber facets have different vertical positions.

Example 11. The method of Example 10, wherein opening widths of the plurality of v-shaped grooves are configured such that the fiber facets have different vertical positions.

Example 12. The method of Example 10, wherein the opening widths of the v-shaped grooves are configured such that the different vertical positions of the fiber facets substantially track different vertical positions of waveguide facets of a photonic integrated circuit (PIC) comprising an array of optical waveguides formed on a PIC substrate, the optical waveguides terminating with the waveguide facets at an edge of the PIC, wherein positions of the waveguide facets along the lateral direction correspond to the lateral positions of the fiber facets.

Example 13. A method of coupling optical fibers to a photonic integrated circuit (PIC) s, the method comprising:
providing a PIC comprising an array of optical waveguides formed on a PIC substrate, the optical waveguides terminating with waveguide facets at an edge of the PIC at lateral positions along a lateral direction along a major surface of the PIC substrate and different vertical positions in a vertical direction orthogonal to a plane corresponding to the major surface of the PIC substrate; and
providing an array of optical fibers disposed on a fiber substrate, the optical fibers terminating with fiber facets arranged along lateral positions along the lateral direction and different vertical positions in the vertical direction, wherein the fiber substrate has a major surface patterned to have different heights such that the vertical positions of the fiber facets substantially track the vertical positions of the waveguide facets.

### Example Embodiments IV

Example 1. A fiber coupled photonic system comprising:
an integrated circuit (PIC) chip comprising an array of optical waveguides, the array of optical waveguides comprising a plurality of waveguide facets arranged at different positions along a first direction parallel to a plane corresponding to a major surface of the PIC chip, at least some of the waveguide facets also having different positions along a second direction orthogonal to the plane corresponding to the major surface of the PIC chip, the plurality of waveguide facets including first and second waveguide facets having different positions along the first direction, wherein the first waveguide facet has a first vertical distance from the second waveguide facet along the second direction; and
an array of optical fibers comprising a plurality of fiber facets arranged at different positions along the first direction, at least some of the fiber facets also having different positions along the second direction, the plurality of fiber facets including first and second fiber facets having different positions along the first direction, wherein a center of a core region of the first fiber facet has a second vertical distance from a center of a core region of the second first fiber facet, along the second direction;
wherein the first vertical distance is substantially equal to the second vertical distance.

Example 2. The fiber coupled fiber coupled photonic system of Example 1, wherein the plurality of waveguide facets include a third waveguide facet having a different position along the first direction with respect to the first and second waveguide facets, wherein the third waveguide facet has a third vertical distance from the first waveguide facet along the second direction, wherein the third vertical distance is different from the first and second vertical distances, wherein the plurality of fiber facets include a third fiber facet, wherein a center of a core region of the third fiber facet has a different position along the first direction with respect to the first and second fiber facets, wherein the third fiber facet has a fourth vertical distance from the first fiber facet along the second direction; and wherein the third distance is substantially equal to the fourth distance.

Example 3. The fiber coupled fiber coupled photonic system of Example 1, wherein the PIC comprises a waveguide layer disposed over a substrate.

Example 4. The fiber coupled fiber coupled photonic system of Example 3, wherein the waveguide layer comprises silicon dioxide and the substrate comprises silicon.

Example 5. The fiber coupled fiber coupled photonic system of Example 4, wherein the optical waveguides comprise silicon nitride waveguides embedded within waveguide layer.

Example 6. The fiber coupled fiber coupled photonic system of Example 1, wherein the PIC has warpage, and the first vertical distance is associated with the warpages.

Example 7. The fiber coupled fiber coupled photonic system of Example 6, wherein the plurality of the optical fibers is mounted on fiber mount comprising a plurality of mounting structures configured to position and stabilize the optical fibers.

Example 8. The fiber coupled fiber coupled photonic system of Example 7, wherein the plurality of mounting structures is configured to establish a relative vertical displacement between the fiber facets according to a warpage profile of the PIC.

Example 9. The fiber coupled fiber coupled photonic system of Example 7, wherein a first and a second mounting structures are configured to position the first and a second fiber facets such that the first vertical distance is substantially equal to the second vertical distance.

Example 10. The fiber coupled fiber coupled photonic system of any one of the Examples 7-9, wherein the mounting structures comprise grooves formed on a fiber substrate.

Example 11. The fiber coupled fiber coupled photonic system of Example 10, wherein the grooves comprise v-shaped grooves.

Example 12. The fiber coupled fiber coupled photonic system of Example 1, further comprising a plurality of microlenses disposed between plurality of waveguide facets and the respective fiber facets.

Example 13. The fiber coupled fiber coupled photonic system of Example 12, wherein microlenses are disposed on the plurality of waveguide facets.

Example 14. The fiber coupled fiber coupled photonic system of Example 12, wherein microlenses are disposed on the plurality of fiber facets.

Example 15. A method of fabricating an optical fiber array for optical coupling to a photonic integrated circuit (PIC) comprising a plurality of waveguide facets arranged at different positions along a first direction, the method comprising:
measuring a warpage profile of the PIC;
determining vertical positions between the waveguide facets along a second direction orthogonal to the first direction, based at least in part on the measured warpage profile;
determining vertical positions between fiber facets of the optical fiber array waveguide facets along the second direction based at least in part on the determined vertical positions between the waveguide facets; and
positioning a plurality of fibers based on the determined vertical positions between fiber facets to form the optical fiber array.

Example 16. The method of Example 15, wherein warpage profile of the PIC comprises variation of a distance between a top major surface of the PIC and a flat plane, along the first direction.

Example 17. The method of Example 15, wherein measuring a warpage profile of the PIC comprises measuring a surface profile of a top major surface of the PIC using a profilometer.

Example 18. The method of Example 15, wherein measuring a warpage profile of the PIC comprises measuring a vertical variation profile of an interface between waveguide layer and a substrate layer of the PIC, along the second direction.

Example 19. The method of Example 15, wherein measuring a warpage profile of the PIC comprises obtaining an image of the waveguide facets and measuring a vertical variation profile of the waveguide facets using the image.

Example 20. The method of Example 15, wherein positioning a plurality of fibers based on the determined vertical positions between fiber facets comprises fabricating a fiber mount having a plurality of grooves and placing a plurality of optical fibers within the plurality of grooves, wherein one or both opening width and depth of at least two grooves are different.

Example 21. A method of fabricating a fiber mount configured to form an optical fiber array for coupling to a warped PIC, the method comprising:
providing a substrate; and
forming an array of grooves on the substrate, the grooves having a dimension determined based at least in part on a measured warpage of the PIC;
wherein a difference between a first and a second dimension is larger than 2%.

Example 22. The method of Example 21, where the grooves comprise v-shaped grooves and the dimension comprises an opening width of an individual v-shaped groove.

Example 23. The method of Example 21, where the grooves comprise rectangular grooves and the dimension comprises a depth of the an individual rectangular groove.

Example 24. A method of fabricating a fiber mount configured to form an optical fiber array for coupling to a warped PIC, the method comprising:
providing a substrate; and
forming an array of mounting structures on the substrate, the mounting structures having a geometrical feature determined based at least in part on a measured warpage of the PIC;
wherein a difference between a first and a second geometrical features is larger than 2%.

### Example Embodiments V

Example 1. A photonic system comprising:
a photonic integrated circuit (PIC) comprising a plurality of optical waveguides formed on a PIC substrate, wherein the PIC substrate has a measurable warpage such that different ones of the optical waveguides have waveguide facets terminating at an edge surface of the PIC at different vertical distances relative to a plane corresponding to a plane corresponding to a major surface of the PIC substrate; and
a plurality of optical fibers disposed on a fiber substrate, the optical fibers terminating with fiber facets corresponding to the waveguide facets, wherein the fiber facets terminate at different vertical distances relative to a plane corresponding to a major surface of the fiber substrate to substantially track the vertical distances of the corresponding waveguide facets.

Example 2. The photonic system of Example 1, wherein the waveguide facets are periodically arranged along a lateral direction parallel to the plane corresponding to the major surface of the PIC substrate.

Example 3. The photonic system of Example 1 or Example 2, wherein the fiber facets are periodically arranged in a lateral direction parallel to the plane corresponding to the major surface of the fiber substrate.

Example 4. The photonic system of Example 1, wherein at least some of the waveguide facets and the corresponding fiber facets are not positioned periodically.

Example 5. The photonic system of any of one the above Examples, wherein the fiber substrate has the major surface patterned such that the different vertical distances of the fiber facets substantially track the different vertical distances of the waveguide facets.

Example 6. The photonic system of any one of the above Examples, wherein the different vertical distances of the waveguide facets are caused by warpage of the PIC during fabrication.

Example 7. The photonic system of any one of the above Examples, wherein the different vertical distances of the fiber facets are caused by different opening widths of grooves formed on the major surface of the fiber substrate.

Example 8. The photonic system of any one of the above Examples, wherein the different vertical distances of the fiber facets are caused by different depths of grooves formed on the major surface of the fiber substrate.

Example 9. The photonic system of any one of Examples 7 and 8, wherein the grooves are positioned at periodic lateral positions.

Example 10. The photonic system of any one of the above Examples, wherein the PIC comprises a waveguide layer disposed over the PIC substrate.

Example 11. The photonic system of Example 10, wherein the waveguide layer comprises silicon dioxide and the PIC substrate comprises silicon.

Example 12. The photonic system of Example 10, wherein the optical waveguides comprise silicon nitride waveguides embedded within waveguide layer.

Example 13. The photonic system of any one of the above Examples, wherein the fiber substrate comprises a fiber mount.

Example 14. The photonic system of Example 13, wherein the fiber mount comprises mounting structures configured to position and stabilize the optical fibers.

Example 15. The photonic system of Example 14, wherein the mounting structures comprise a plurality of grooves having different depths.

Example 16. The photonic system of Example 15, wherein the plurality of grooves comprises a plurality of v-shaped grooves.

Example 17. The photonic system of Example 16, wherein the plurality of v-shaped grooves is configured to establish relative vertical displacements between the fiber facets.

Example 18. The photonic system of any one of the above Examples, further comprising a plurality of microlenses disposed between plurality of waveguide facets and the corresponding fiber facets.

Example 19. The photonic system of Example 18, wherein the plurality of microlenses are disposed on the waveguide facets.

Example 20. The photonic system of Example 18, wherein the plurality of microlenses are disposed on the fiber facets.

### ADDITIONAL CONSIDERATIONS

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

In the embodiments described above, apparatus, systems, and methods for sensing electrical overstress events are described in connection with particular embodiments. It will be understood, however, that the principles and advantages of the embodiments can be used for any other systems, apparatus, or methods with a need for sensing and/or protecting against electrical overstress events.

The principles and advantages described herein can be implemented in various apparatuses. Examples of such apparatuses can include, but are not limited to, consumer electronic products, parts of the consumer electronic products, electronic test equipment, etc. Examples of parts of consumer electronic products can include clocking circuits, analog to digital converts, amplifiers, rectifiers, programmable filters, attenuators, variable frequency circuits, etc. Examples of the electronic devices can also include memory chips, memory modules, circuits of optical networks or other communication networks, and disk driver circuits. Consumer electronic products can include, but are not limited to, wireless devices, a mobile phone (for example, a smart phone), cellular base stations, a telephone, a television, a computer monitor, a computer, a hand-held computer, a tablet computer, a laptop computer, a personal digital assistant (PDA), a microwave, a refrigerator, a stereo system, a cassette recorder or player, a DVD player, a CD player, a digital video recorder (DVR), a VCR, an MP3 player, a radio, a camcorder, a camera, a digital camera, a portable memory chip, a washer, a dryer, a washer/dryer, a copier, a facsimile machine, a scanner, a wrist watch, a smart watch, a clock, a wearable health monitoring device, etc. Further, apparatuses can include unfinished products.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings of the inventions provided herein can be applied to other systems, not necessarily the systems described above. The elements and acts of the various embodiments described above can be combined to provide further embodiments. The acts of the methods discussed herein can be performed in any order as appropriate. Moreover, the acts of the methods discussed herein can be performed serially or in parallel, as appropriate.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. Accordingly, the scope of the present inventions is defined by reference to the claims.

What is claimed is:

1. A photonic system comprising:
a photonic integrated circuit (PIC) comprising a plurality of optical waveguides formed on a PIC substrate, different ones of the optical waveguides having waveguide facets terminating at an edge surface of the PIC at different vertical distances relative to a plane corresponding to a major surface of the PIC substrate; and
a plurality of optical fibers disposed on a fiber substrate, the optical fibers terminating with fiber facets corresponding to the waveguide facets, wherein different ones of the fiber facets terminate at different vertical distances relative to a plane corresponding to a major surface of the fiber substrate,
wherein the different vertical distances of the fiber facets substantially track the different vertical distances of the corresponding waveguide facets.

2. The photonic system of claim 1, wherein the waveguide facets are periodically arranged along a lateral direction parallel to the plane corresponding to the major surface of the PIC substrate.

3. The photonic system of claim 2, wherein the fiber facets are periodically arranged in a lateral direction parallel to the plane corresponding to the major surface of the fiber substrate.

4. The photonic system of claim 1, wherein at least some of the waveguide facets and the corresponding fiber facets are not positioned periodically.

5. The photonic system of claim 1, wherein the fiber substrate has the major surface patterned such that the different vertical distances of the fiber facets substantially track the different vertical distances of the waveguide facets.

6. The photonic system of claim 1, wherein the different vertical distances of the waveguide facets are caused by warpage of the PIC during fabrication.

7. The photonic system of claim 1, wherein the different vertical distances of the fiber facets are caused by different opening widths of grooves formed on the major surface of the fiber substrate.

8. The photonic system of claim 1, wherein the different vertical distances of the fiber facets are caused by different depths of grooves formed on the major surface of the fiber substrate.

9. The photonic system of claim 7, wherein the grooves are positioned at periodic lateral positions.

10. The photonic system of claim 1, wherein the PIC comprises a waveguide layer disposed over the PIC substrate.

11. The photonic system of claim 10, wherein the waveguide layer comprises silicon dioxide and the PIC substrate comprises silicon.

12. The photonic system of claim 10, wherein the optical waveguides comprise silicon nitride waveguides embedded within the waveguide layer.

13. The photonic system of claim 1, wherein the fiber substrate comprises a fiber mount.

14. The photonic system of claim 13, wherein the fiber mount comprises mounting structures configured to position and stabilize the optical fibers.

15. The photonic system of claim 14, wherein the mounting structures comprise a plurality of grooves having different depths.

16. The photonic system of claim 15, wherein the plurality of grooves comprises a plurality of v-shaped grooves.

17. The photonic system of claim 16, wherein the plurality of v-shaped grooves is configured to establish relative vertical displacements between the fiber facets.

18. The photonic system of claim 1, further comprising a plurality of microlenses disposed between the waveguide facets and the corresponding fiber facets.

19. The photonic system of claim 18, wherein the plurality of microlenses are disposed on the waveguide facets.

20. The photonic system of claim 18, wherein the plurality of microlenses are disposed on the fiber facets.
